(19) United States
(12) Patent Application Publication
(10) Pub. No.: US 2022/0030344 A1
(43) Pub. Date: Jan. 27, 2022

(54) Wireless Headphones

(71) Applicant: Roody Mamouzette, Hyde Park, MA (US)

(72) Inventor: Roody Mamouzette, Hyde Park, MA (US)

(21) Appl. No.: 17/097,089

(22) Filed: Nov. 13, 2020

Related U.S. Application Data
(60) Provisional application No. 63/055,957, filed on Jul. 24, 2020.

(51) Int. Cl. H04R 1/10

(52) U.S. Cl. CPC H04R 1/1008

(57) ABSTRACT

A set of wireless headphones configured for simultaneous connectivity with multiple electronic devices. The set of wireless headphones is configured to pair with the electronic devices via Bluetooth® or similar electronic connection. The set of wireless headphones comprise a pair of on-ear or over-ear earphones connected via a headband configured to fit a user's head. A touchscreen is embedded in one of the earphones for allowing the user to input or accept commands. A controller is configured to accept and convert received text messages to an audio format, and to convert a voice message to text.

### CROSS-REFERENCE TO RELATED APPLICATION

The present application claims priority to, and the benefit of, U.S. Provisional Application No. 63/055,957, which was filed on Jul. 24, 2020 and is incorporated herein by reference in its entirety.

### BACKGROUND

The present invention generally relates to a set of wireless headphones, and more specifically to a set of wireless headphones configured to connect with other electronic devices. Accordingly, the present specification makes specific reference thereto. However, it is to be appreciated that aspects of the present invention are also equally amenable to other like applications, devices and methods of manufacture.

Headphones offer a way to experience the best quality of sound while eliminating background noise. Unlike speakers, which can provide a fantastic quality of sound, headphones allow a much greater immersion because they can cancel out the outside noise and any similar distractions. This is, for example, very important if the user would like to listen to an audio book but can't focus because of distractions and ambient noise. Similarly, this feature is also very beneficial when it comes to playing video games or watching a movie or video. Headphones also make it possible for the user to enjoy whatever they are listening to as loud as they want, without disturbing anyone eke.

Standard wired headphones use a wired connection to connect with a device. This wired connection can be inconvenient when trying to connect the headphones with a specific port on the device. Additionally, these headphones are only able to be used with a single electronic device specifically configured to interact and connect with the specific headphones. Typically, each electronic device must have a separate set of headphones unless they have a universal port. Even if devices have universal ports, the headphones must have a similar capability, Additionally, the headphones with a universal connection are still only able to be connected to a single device at any given time limiting their functionality. The user must unplug the universal headphones from one device and plug it in to the next device to use the next device.

Texting while driving is the act of composing, sending, or reading text messages while operating a motor vehicle. This is a dangerous activity as it distracts the driver as they take their eyes off of the road while they are engaged in texting. It is even illegal in many cities, states, and countries as distracted driving has been demonstrated to significantly increases the chances that the driver will be involved in or cause a motor vehicle accident. The same danger is true for users who check the internet, read and answer emails or instant messages, or interact with an electronic device while driving.

Despite the acknowledgment of the dangers of texting, using the internet, or interacting with an electronic device while driving, many drivers still engage in these activities on a regular basis according to numerous studies. Some studies even rate the dangers of texting or internet surfing and driving above driving while intoxicated or otherwise impaired. Parents can block their children's phones while driving in response but typically fail to do so. Additionally, they do not disable their own phones while driving. Car manufacturers have adopted pairing systems that allow the user to make hands free phone calls and receive verbal translations of texts while driving. Unfortunately, this technology is not yet widespread, and is not present in older or low end new vehicles. Even when present, it is not always used.

In this manner, the improved wireless headphones of the present invention accomplishes all of the forgoing objectives, thereby providing an easy solution to simultaneous connectivity with multiple electronic devices. A primary feature of the present invention is a user input integrated into the headphones which enables a user to communicate with electronic devices. The improved wireless headphones of the present invention are capable of allowing the user to be simultaneously connected to multiple electronic devices and electronically communicate without the need to view a display screen.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a set of wireless headphones. The set of wireless headphones is configured to simultaneously communicate with multiple electronic devices. A wireless electronic connection or pairing between the set of wireless headphones and the multiple electronic devices is typically a Bluetooth® connection. The set of wireless headphones allows a user to receive and send texts in an audio format.

The set of wireless headphones comprise a pair of earphones connected by a head band. The pair of earphones may be on-ear or over-ear earphones. Each earphone comprises a housing, an earpad, and a speaker. The set of wireless headphones further comprises a touchscreen. The touchscreen is integrated into the housing of one of the pair of earphones. The touchscreen comprises a user input and is configured to receive tactile input from a user. The touchscreen is also configured to display virtual controls and other visual content received from one of the connected electronic devices.

The set of wireless headphones further comprises a controller. The controller is in electronic communication with the touchscreen. The controller comprises a processor and a computer-readable memory. The controller further comprises an electronic communications module. The electronic communications module comprises a transmitter and a receiver. The electronic communications module is configured to send and receive electronic signals. The controller is further configured to convert a received electronic text message into an audio message that is accessible by the user via the speakers in the pair of earphones.

The set of wireless headphones further comprises a microphone. The microphone is integrated into one of the pair of earphones. The set of wireless headphones may further comprise a second microphone. Either the first of second microphones may comprise an extendable portion. The extendable portion may be retractable, bendable, or may be fixed in position so that the microphone is positioned away from the earphone closer to the user's mouth. The controller is further configured to convert a voice command or message received by either microphone to an electronic text message. The transmitter of the communications module can then send the electronic text message via one of the multiple electronic devices that are paired or synced to the set of wireless headphones.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of a set of wireless headphones of the present invention in electronic communication with an electronic device in accordance with the disclosed architecture.

FIG. 2 illustrates a perspective view of the set of wireless headphones of the present invention in accordance with the disclosed architecture.

FIG. 3 illustrates a close up view of a microphone of the set of wireless headphones of the present invention in accordance with the disclosed architecture.

FIG. 4 illustrates a perspective view of the microphone and a second microphone of the set of wireless headphones of the present invention in accordance with the disclosed architecture.

FIG. 5 illustrates an exploded view of one of a pair of earphones of the set of wireless headphones of the present invention in accordance with the disclosed architecture.

FIG. 6 illustrates an exploded view of one of the pair of earphones of the set of wireless headphones of the present invention in accordance with the disclosed architecture.

FIG. 7 illustrates a touchscreen embedded in a housing of one of the pair of earphones of the set of wireless headphones of the present invention in accordance with the disclosed architecture.

FIG. 8 illustrates a block diagram of a controller for controlling the set of wireless headphones of the present invention in accordance with the disclosed architecture.

FIG. 9 illustrates a perspective view of the pair of wireless headphones of the present invention in electronic communication with an electronic device in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a wireless headphone device with texting capability. The headphones have at least one microphone for verbally communicating with others. The headphones are connectable to a plurality of electronic devices, such as, smartphones, smart televisions, computers, smart devices, video game systems, and the like via Bluetooth® or other wireless connections. The headphones comprise a touchscreen mechanism on one earphone which enables the user to send and receive text messages in an audible format. The headphones can send an audible alert upon receipt of a text or other electronic communication which can then be played through the earphones. Alternatively, the text may be read on the touchscreen mechanism if it is safe to do so. The invention offers a multifunctional set of headphones capable of communication with almost any type of electronic device.

The headphones can be wirelessly paired with the electronic devices. The touchscreen may be used to send and receive the electronic messages. The at least one microphone may be built into the headphones, may be extendable and retractable, or may be a combination of both. Once the headphones are connected to an electronic device via a wireless connection, the wearer can utilize the headphones for listening and communicating via the at least one microphone. If the headphones are paired to a smartphone, the user can answer a text message by simply pressing the touchscreen. The message can read or translated and spoken audibly into the earphones. A small button on the side can extend the microphone as needed. The multifunctional headphones offer a variety of options for connecting to almost any smart electronic device without the inconvenience of a wired connection.

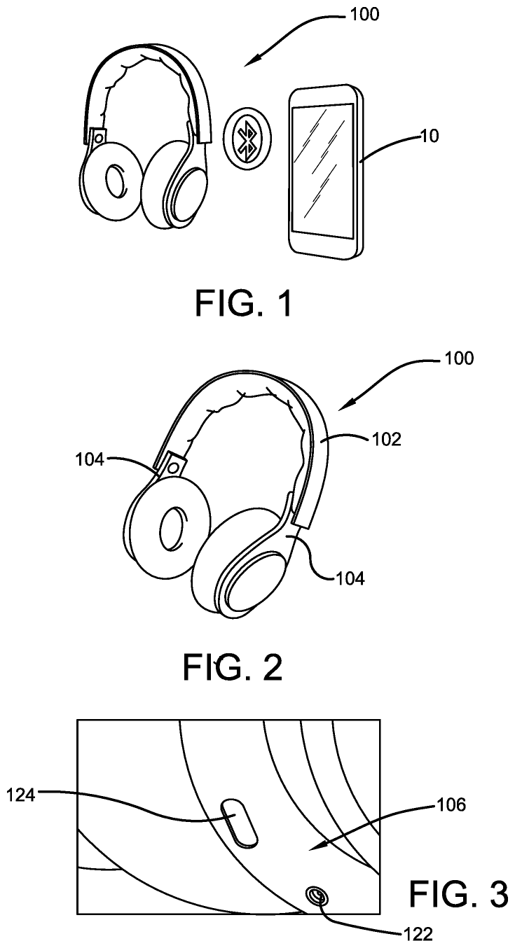

Referring initially to the drawings, FIG. 1 illustrates a set of wireless headphones 100. The set of wireless headphones 100 is configured to simultaneously communicate with multiple electronic devices 10, such as, but not limited to a smartphone, a smart device, an electronic tablet, an electronic pad, a computer, a smart speaker, a smart television, a video game system, a vehicle sound system, and the like. A wireless electronic connection, such as pairing or syncing between the set of wireless headphones 100 and the multiple electronic devices 100 is typically accomplished via a Bluetooth® or similar wireless connection as illustrated in FIG. 9. The wireless electronic connection also allows a user to receive and send texts via one of the multiple electronic devices 10 through the set of wireless headphones 100 in an audio format.

As illustrated in FIG. 2, the set of wireless headphones 100 comprises a pair of earphones 106 and a head band 102. Each of the earphones 106 is adjustably and movably connected to one of a pair of ends 104 of the head band 102. The head band 102 is generally arcuate in shape and is adjustable in length so to adapt to and fit the shape of a user's head. The pair of earphones 100 may be a pair of on-ear or over-ear earphones.

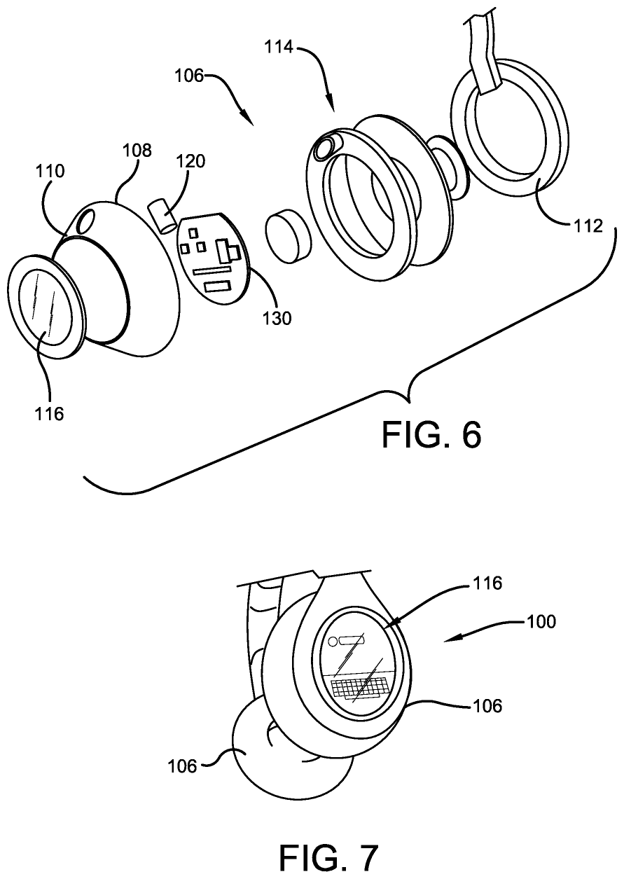

As illustrated in FIGS. 5 and 6, each earphone 106 comprises a housing 108, an earpad 112, and a speaker 114. The housing 108 is typically constructed from a plastic material and comprises an outside facing portion 110. The speaker 114 may be a driver component comprising a magnet, voice coil, and diaphragm combination, or any similar speaker configuration usable with a set of headphones.

As illustrated in FIG. 7, the set of wireless headphones 100 further comprises a touchscreen 116. The touchscreen 116 is an input/output device using an electronic visual display of an information processing system as described infra. The touchscreen 116 is integrated into or attached to the outside facing portion 110 of the housing 108 of one of the pair of earphones 106. The touchscreen 116 is an LCD or OLED display comprising a user input 118 and is configured to receive tactile input from a user. The user input 118 may be an electronic keyboard or any other input capable of accepting multi-touch gestures. The touchscreen 116 is also configured to display virtual controls and other visual content received from a connected electronic device 10.

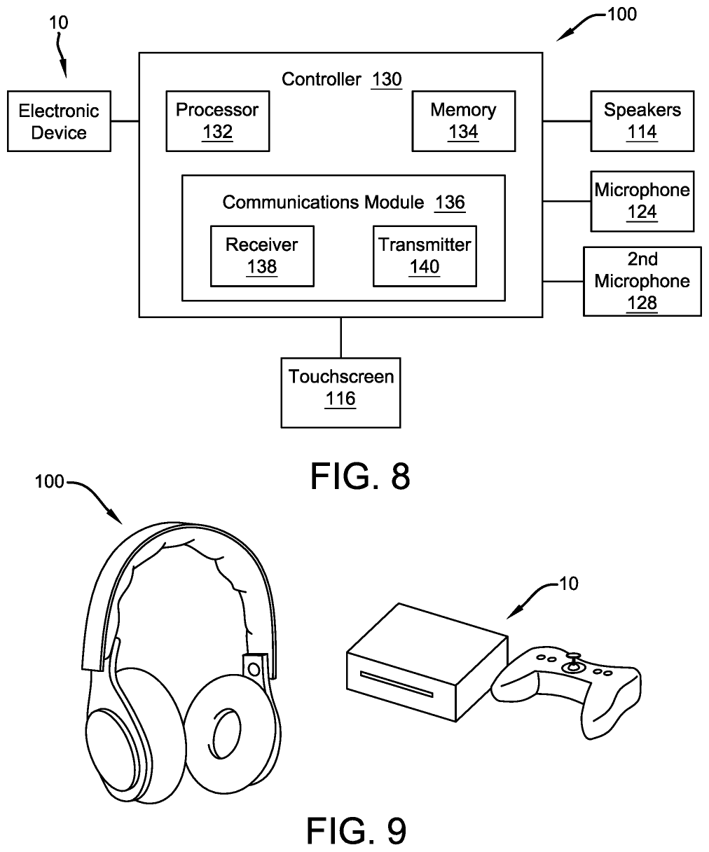

As illustrated in FIG. 8, the set of wireless headphones 100 further comprises a controller 130. The controller 130 is in electronic communication with the touchscreen 116 and the speakers 114. The controller 130 comprises a processor 132 and a computer-readable memory 134. The controller 130 further comprises an electronic communications module 136. The electronic communications module 136 comprises a transmitter 138 and a receiver 140. The electronic communications module 136 is configured to send and receive electronic signals between the set of wireless headphones 100 and the multiple electronic devices 10 via Bluetooth® or similar wireless technology. The controller 130 is further configured to convert a received electronic text message from one of the multiple electronic devices 10 into an audio message that is accessible by the user via the speakers 114 in each of the pair of earphones 106.

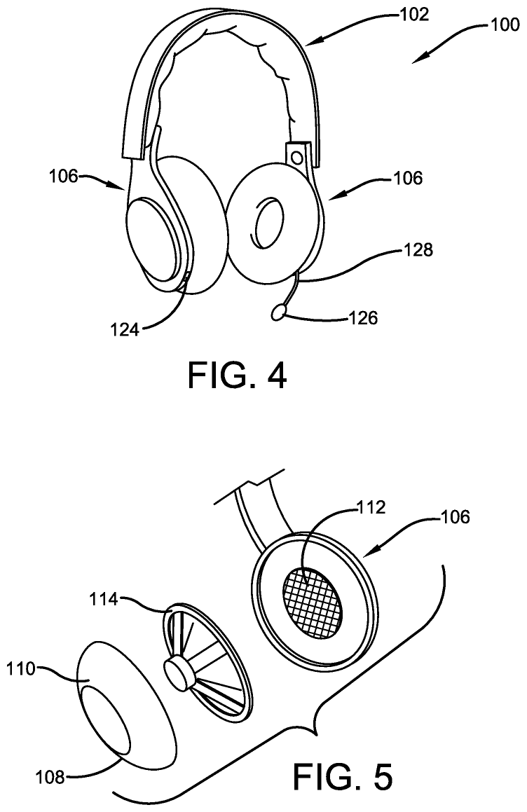

As illustrated in FIG. 3, the set of wireless headphones 100 further comprises a microphone 124. The microphone 124 is integrated into the housing 108 of one of the pair of earphones 106 and is in electronic communication with the controller 130. As illustrated in FIG. 4, the set of wireless headphones 100 may further comprise a second microphone 126. Either the first of second microphones 124 or 126 may comprise an extendable portion 128. The extendable portion 128 may be a small flexible boom or extension that is retractable, bendable, or may be fixed in position so that the microphone 124 or 126 is positioned away from the earphone 106 closer to the user's mouth. The controller 130 is further configured to convert a voice command or message received by either microphone 124 or 126 to an electronic text message. The transmitter 140 of the communications module 136 can then send the electronic text message via one of the multiple electronic devices 10 that are paired or synced to the set of wireless headphones.

As illustrated in FIG. 6, the set of wireless headphones 100 further comprises a battery 120. The battery 120 may be a capacitor and may be rechargeable. As illustrated in FIG. 5, the set of wireless headphones 100 may further comprise a charging port 122. The charging port 122 is typically integrated into the housing 108 of the earphone 106 that houses the battery or capacitor 120. The charging port 122 may be adapted to receive an electronic connecter, such as, but not limited to, a lightning cable, a universal charging cable, a USB connection, a micro or micro-USB charger, or the like. The battery or capacitor 120 may alternatively be adapted for use with a wireless charging mat or system. The touchscreen 116 may be configured to go idle when not in use to further conserve energy.

It is contemplated that the set of wireless headphones 100 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A set of wireless headphones comprising:
a pair of earphones each comprising a speaker;
a touchscreen integrated into one of the pair of earphones; and
a controller in electronic communication with the touchscreen comprising an electronic communications module.

2. The set of wireless headphones of claim 1, wherein the controller is configured to convert an electronic text message to an audio format.

3. The set of wireless headphones of claim 1, wherein the controller is configured to convert a voice message to an electronic text message.

4. The set of wireless headphones of claim 1 further comprising a rechargeable battery or a capacitor.

5. The set of wireless headphones of claim 1, wherein the touchscreen is configured to receive tactile input from a user.

6. The set of wireless headphones of claim 1, wherein the touchscreen is configured to display virtual controls.

7. The set of wireless headphones of claim 1, wherein the set of wireless headphones are adapted to wirelessly communicate with one or more electronic devices using Bluetooth® technology.

8. The set of wireless headphones of claim 1, wherein each of the pair of earphones are on-ear or over-ear earphones.

9. A set of wireless headphones comprising:
a head band;
a pair of earphones connected by the head band each comprising a speaker;
a touchscreen integrated into one of the pair of earphones;
a controller in electronic communication with the touchscreen comprising an electronic communications module; and
a microphone.

10. The set of wireless headphones of claim 9, wherein the touchscreen is configured to receive tactile input from a user and display virtual controls.

11. The set of wireless headphones of claim 9, wherein the touchscreen comprises a user input.

12. The set of wireless headphones of claim 9, wherein the microphone is integrated into a housing of one of the pair of earphones.

13. The set of wireless headphones of claim 9, wherein the controller further comprises a processer and a computer-readable memory.

14. The set of wireless headphones of claim 9, wherein the communications module comprises a transmitter and a receiver.

15. The set of wireless headphones of claim 9 further comprising a charging port.

16. A set of wireless headphones for simultaneously communicating with more than one electronic device, the set of wireless headphones comprising:
a head band;
a pair of earphones connected by the headband each comprising a speaker;
a touchscreen integrated into one of the pair of earphones;
a controller in electronic communication with the touchscreen comprising an electronic communications module; and
a microphone integrated into a housing of one of the pair of earphones; and
wherein the controller is configured to convert an electronic text message to an audio format and convert a voice message to an electronic text message.

17. The set of wireless headphones of claim 16, wherein the touchscreen is configured to receive tactile input from a user and display virtual controls.

18. The set of wireless headphones of claim 16 further comprising a second microphone integrated into the housing of one of the pair of earphones.

19. The set of wireless headphones of claim 18, wherein the second microphone is extendable from the housing.

20. The set of wireless headphones of claim 16, wherein the set of wireless headphones are adapted to wirelessly communicate with one or more electronic devices using Bluetooth® technology.
